(19) United States
(12) Patent Application Publication
(10) Pub. No.: US 2020/0311786 A1
(43) Pub. Date: Oct. 1, 2020

(54) SYSTEM AND METHOD FOR AGGREGATION OF PROCUREMENT REQUISITIONS INCLUDING TIERED PRICING MODULE

(71) Applicant: Zycus Infotech Pvt. Ltd., Mumbai (IN)

(72) Inventors: Durga Prasad, Mumbai (IN); Vijesh Bhaktha, Mumbai (IN); Alok Jain, Mumbai (IN)

(73) Assignee: Zycus Infotech Pvt. Ltd., Mumbai (IN)

(21) Appl. No.: 16/810,549

(22) Filed: Mar. 5, 2020

(30) Foreign Application Priority Data
Mar. 28, 2019 (IN) 201921012226

(51) Int. Cl. G06Q 30/06

(52) U.S. Cl. CPC G06Q 30/0605; G06Q 30/0635; G06Q 30/0603

(57) ABSTRACT

A system and method for aggregation of procurement requisitions including tiered pricing module is described in the present invention. The computer implemented system aggregates the approved procurement requisitions in real time from different business departments. They are then kept in a gestation period for channelizing the aggregated quantity of the aggregated requisitions into one common purchase order to avail bulk discounts or to avail tiered pricing discounts from the supplier. Once the aggregation of requisitions is done, accordingly based on the decision rules, the tiered pricing catalogue is triggered to select the right catalogue and the quantity/volume and its related price. If the aggregated requisitions do not match the tiered pricing catalogue then the system directs the user to negotiate discount with the supplier for the requisitions. The user thus avails maximum discounts on the aggregated requisitions.

### CROSS-REFERENCE TO RELATED APPLICATION

The instant application claims priority to Indian Patent Application Serial No. 201921012226, filed Mar. 28, 2019, pending, the entire specification of which is expressly incorporated herein by reference.

### FIELD OF THE INVENTION

The present invention relates to a computer implemented system and method for aggregation of procurement requisitions including a tiered pricing module.

### BACKGROUND OF THE INVENTION

Current e-commerce systems and methods provide consumers and businesses with the ability to browse product lines and consummate sales transactions. However, current e-commerce systems do not allow for easy customization of the needed functionality to facilitate the transaction. While current systems can be customized for a specific business or customer, the customization is a time consuming and complicated task. These customizations must generally be hard coded into the application by the developers, thereby incurring increases in costs, delay in implementation, and loss of productivity. In the field of procurement, for example, an organization in need of a product or service generally has contractual relationships with multiple vendors to provide the desired product or service. The contractual relationship may define such terms as price, lot size, form of delivery, amount of discount, and other business rules. These rules may become complex as one term may influence other terms, such as different levels of discounts based on the number of items ordered.

Procurement systems also generally require order authorization from a procurement officer of the organization or someone in charge of reviewing the orders for compliance with internal policies of the organization, in addition to the contractual relationships with the vendors. These orders must be processed and tracked as the orders progress through the approval process such that the individuals placing orders are notified of whether the order was approved or denied, as well as for internal audit purposes.

Therefore, there is a need for a system and method that can provide an efficient and simple procurement process that is easily customizable for multiple organizations and multiple vendors with simple and complex business terms, and can also provide a single point-of-access for both businesses and consumers to interface, interact, and implement and execute transactions, in accordance with existing or newly defined relationships, using a custom and configurable methodology for realizing their requirements.

### OBJECTS OF THE INVENTION

The object of the present invention is to provide a computer implemented system to aggregate different procurement requisitions from different business units in an intelligent manner.

Another object of the present invention is to provide a computer implemented system and a method to process the aggregated requisitions into one large purchase order to avail maximum discounts.

Another object of the present invention is to provide a computer implemented system including a tiered pricing catalogue module for maximum benefits to the user.

### SUMMARY OF THE INVENTION

Before the present invention is described, it is to be understood that the present invention is not limited to specific methodologies and materials described, as these may vary as per the person skilled in the art. It is also to be understood that the terminology used in the description is for the purpose of describing the particular embodiments only and is not intended to limit the scope of the present invention.

The present invention describes a novel computer implemented system and method is which aggregates the approved procurement requisitions in real time from different business units and departments in an organization. Once the approved procurement requisitions are aggregated, they are kept in a gestation period for channelizing the aggregated quantity of the aggregated requisitions into one common purchase order to avail bulk discounts or to avail tiered pricing discounts from the supplier. Each requisition raised by each user is approved by the hierarchy of work flow. The aggregation of procurement requisitions in the system triggers a check for tiered pricing availability by the user and a bulk discount check from the supplier. Once the aggregation of requisitions is done by the system in accordance with the above method, accordingly based on the decision rules, the tiered pricing catalogue is triggered to select the right catalogue and the quantity/volume and its related price. If the aggregated requisitions do not match the tiered pricing catalogue then the system directs the user to negotiate discount with the supplier for the requisitions. Hence the user can avail maximum discounts on the aggregated requisitions and in turn can save expenditure too.

### DETAILED DESCRIPTION OF THE INVENTION

In the procurement systems generally available to the users, requisitions are raised by the users or their organizations for procuring various items and services. In such procurement systems there is process that any user who wants to procure any item will raise a requisition by using requisition forms, such requisition will contain details of item, quantity, its price, preferred vendor and other details. The requisition as raised by the user will be approved by user workflow, before it goes to purchasing department for raising purchase order for that requisition. This purchase order then goes to the vendor or supplier.

There are different departments in an organization. In each department of that particular organization, there are many users who raise requisitions for procuring items and services required for their department or for their use. However in the presently available procurement systems there are no provisions to aggregate these requisitions in an intelligent manner and process the aggregated requisitions into one large purchase order to avail possible discounts from the supplier. These available systems rather process each requisition separately and individually. Aggregation of requisitions from different departments for the same item helps to negotiate with supplier for bulk discount, negotiating better price and making other procurement analysis.

In the present invention, a novel computer implemented system and method is provided which aggregates the approved procurement requisitions in real time from different business units and departments in an organization. Once the approved procurement requisitions are aggregated, they are kept in a gestation period for channelizing the aggregated quantity of the aggregated requisitions into one common purchase order to avail bulk discounts or to avail tiered pricing discounts from the supplier. Each requisition raised by each user is approved by the hierarchy of work flow. However, unlike the general process, it does not go directly to the buyer desk or the procurement department for raising purchase order for each such requisition. Each requisition once approved is put into a folder, for some time interval, waiting time (gestation period) to see if there are other requisitions raised by other departments or other users for similar item, and if such requisitions are pulled into such folder. Once the folder has more than one requisition to aggregate, it is further channelized or processed for further steps.

The aggregated requisitions containing requested aggregated quantities of items are used by the central procurement team to negotiate price with vendor, the negotiated price and aggregated quantity are then put into one purchase order for placing order for the quantity mentioned in aggregated requisitions.

In the given embodiment of the present invention, the aggregation of procurement requisitions is done based on certain criteria and rules. They primarily include category and sub category of items which are required to be purchased, business units of same location/region, urgency for procuring the item, supplier marked in the requisition and other heuristic patterns. For example, the sales department raises requisition for purchasing pens, the product department also raises requisition for purchasing pens, therefore the decision rule for aggregation of requisition is at item level i.e. pens. Heuristic patterns are self learning patterns by the system to aggregate requisitions. For example, if certain requisitions are aggregated into one purchase order manually, the system understands that manual aggregation as well to present its own auto aggregation of requisitions.

In the given embodiment of the present invention, for aggregation of requisitions, the system allots gestation period to the requisitions. Hence gestation period or hold period is important for deciding aggregation of requisitions. During this time the requisitions are aggregated. The approved requisitions are put into a gestation period for aggregation. The gestation period can be of few hours, one day or two days depending upon the decision rules or the criteria attached for the gestation period. The duration of the gestation period depends on various user configurable decision rules. Whether or not any requisition needs to be put into gestation period also depends on various user configurable decision rules. The system of the present invention decides which step to choose depending on the decision rules or criteria.

The system of the present invention analyzes the following criteria for deciding the gestation period. The decision is based on category and sub category of items which are required to be purchased, business units of same location/region, urgency for procuring the items, supplier marked in the requisition or based on other heuristic patterns. For example: user can set criteria for gestation period or aggregation for example the purchasing department can allow aggregation of two business units which are a fixed distance apart. Further one can allow aggregation for particular items and exclude aggregation of certain critical items.

Once the procurement requisitions are aggregated, the aggregated requisitions increase the volume and the quantity of purchase. With a bulk order for purchase, a bulk discount from the supplier can be obtained. The system will prompt opportunities to purchasing department to negotiate with one supplier and provide the entire deal if that supplier gives additional bulk discount. Hence aggregation creates opportunities for savings as well.

In another embodiment of the present invention, the aggregation of procurement requisitions in the system triggers a check for tiered pricing availability by the user and a bulk discount check from the supplier.

There are various price catalogues stored in a procurement system. These catalogues contain price and item information. In a tiered pricing catalogue arrangement, for same item there are different catalogues carrying different prices based on volume and quantity. In the given embodiment of the present invention, once the aggregation of requisitions is done by the system in accordance with the above method, accordingly based on the decision rules, the tiered pricing catalogue is triggered to select the right catalogue and the quantity/volume and its related price. If the aggregated requisitions do not match the tiered pricing catalogue then the system directs the user to negotiate discount with the supplier for the requisitions.

For example for a given item, there are three catalogues. The first one quotes the price as X for minimum order quantity as 2, second catalogue quotes the price as Y (less than X) for a minimum order quantity as 4 for the same item and the third catalogue quotes the price as Z (less than X and Y) for a minimum quantity of 6 for the same item.

The system of the present invention allows for side-constraints, volume-based discounts, and other adjustments from the suppliers. For example, the supplier might include the following kinds of discounts and constrains: multi-item quantity discounts; e.g., if 1000 units of items A and B are procured then the unit price will fall by 5% on future purchases of A, B and C; multi-item single-order tiered pricing; e.g., if 1000 units each of items A and B are purchased in a single purchase order then the per-unit price is 5% less. Tiered pricing includes aspects of volume based discounts. Thus tiered pricing is more of display of catalogues based on quantity and price, a user before procuring any item may select more quantity to avail volume discount included in tiered pricing catalogue.

Sometimes when one user raises a requisition for only one quantity of a particular item and does not wish to procure more than one, tiered pricing catalogues are not applicable to those users. In such circumstances, aggregation of requisitions helps to select price reflected in tiered pricing catalogues because of increased quantity of the item. If tiered pricing catalogues are not available for that item for which requisitions are aggregated then the purchasing department starts negotiation with specific supplier for availing bulk discount.

The disclosure has been described with reference to the accompanying embodiments which do not limit the scope and ambit of the disclosure. The description provided is purely by way of example and illustration.

The embodiments herein above and the various features and advantageous details thereof are explained with reference to the non-limiting embodiments in the following description. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification, the word “comprise,” or variations such as “comprises” or “comprising,” will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of files, acts, materials, devices, articles or the like that has been included in this specification is solely for providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A computer implemented method for aggregation of a plurality of procurement requisitions from a plurality of business departments in an organisation consisting of a tiered pricing catalogue module so as to process the aggregated requisitions into at least one purchase order, comprising the steps of:
raising a procurement requisition for procuring items and services by one of the plurality of users from a plurality of departments in a requisition form;
approving the raised procurement requisitions by a hierarchy of work flow;
accumulating the approved requisitions in at least one folder for a pre determined gestation period based on a plurality of decision rules and criteria;
aggregating the approved procurement requisitions from plurality of users for same item and services into at least one single purchase order based on a plurality of decision rules and criteria;
placing the purchase order with the aggregated quantity of the procurement requisitions with at least one corresponding supplier; and
checking the availability for tiered pricing catalogue module and availing bulk discount from the supplier for the aggregated procurement requisitions.

2. The method as claimed in claim 1, wherein the decision rules and criteria are user configurable.

3. The method as claimed in claim 1, wherein the requisition form comprises of details of item, its quantity, its price and preferred vendor.

4. The method as claimed in claim 1, wherein the decision rules and criteria for aggregation of procurement requisitions are at least one selected from category and sub category of items which are required to be purchased, business units of same location and region, urgency for procuring the item, supplier marked in the requisition form and heuristic patterns.

5. The method as claimed in claim 4, wherein the heuristic patterns are self learning patterns by the system to aggregate requisitions when manual aggregations are entered.

6. The method as claimed in claim 1, wherein the decision rules and criteria for deciding the gestation period are at least one selected from category and sub category of items which are required to be purchased, business units of same location and region, urgency for procuring the items, supplier marked in the requisition and heuristic patterns.

7. The method as claimed in claim 1, wherein the tiered pricing catalogue module has a plurality of catalogues having a plurality of prices for the same item based on volume and quantity.
